(19) United States
(12) Patent Application Publication
(10) Pub. No.: US 2014/0143028 A1
(43) Pub. Date: May 22, 2014

(54) SELF-GOVERNANCE OF AN ONLINE COMMUNITY

(71) Applicant: Eunum, LLC, Roseville, MN (US)

(72) Inventors: William Howe, Chicago, IL (US); George Michalopoulos, Chicago, IL (US); Chhay Tea, Northbrook, IL (US)

(73) Assignee: Eunum, LLC, Roseville, MN (US)

(21) Appl. No.: 14/082,103

(22) Filed: Nov. 16, 2013

Related U.S. Application Data
(60) Provisional application No. 61/727,475, filed on Nov. 16, 2012.

(51) Int. Cl. G07C 13/00; G06Q 50/00

(52) U.S. Cl. CPC G07C 13/00; G06Q 50/01
USPC 705/12

(57) ABSTRACT

Embodiments disclosed herein provide systems and methods that allow users to self-organize and build self-governed online communities around any topic or genre of interest, such as sports, news, politics, science, and/or broader or more specific topics. The online communities may be groups of like-minded individuals who can govern themselves by democratically selecting leaders and rules. The selection process for leaders and/or rule may be automatic using algorithms, based on voting, or a combination of both.

This application claims priority to U.S. provisional patent application No. 61/727,475, filed Nov. 16, 2012, which is hereby incorporated by reference in its entirety.

### TECHNICAL FIELD

This disclosure relates generally to systems and methods for self governance of an online community. Specifically, this disclosure relates to self governance of an online community with trigger events associated with voting for an election and/or a rule.

### BACKGROUND

In recent years there has been an increase in the prevalence of online communities. Online communities may allow groups of likeminded users to be formed around any topic they are interested in.

Currently, rules for governing online communities are decided from the top down, with administrators deciding what actions or permissions are allowed and not allowed for the online community. Conventionally, administrators for an online community are selected by a user requesting to be an administrator, and then a site owner approving the request. Conventional online communities only allow users to vote on a general layout of content such as the placement and ranking of content.

Traditional governance of online communities is ineffective or otherwise less than desirable because users are not governed by administrators and rules which they chose through a democratic process. Accordingly, needs exists for online communities to be governed by democratic processes.

### SUMMARY

Embodiments disclosed herein provide systems and methods that allow users to self-organize and build self-governed online communities around any topic or genre of interest, such as sports, news, politics, science, geographic area, cultural heritage, and/or broader or more specific topics. The online communities may be groups of like-minded individuals who can govern themselves by democratically selecting leaders and rules. The selection process for leaders and/or rules may be automated using algorithms, based on voting, or a combination of both.

It should be understood that any time a singular administrator (or similar) or rule is referenced, plural administrators or rules can be substituted. In other words, a single election process can elect multiple administrators or rules at the same time, using the same process.

In certain embodiments, the democratic process for governing an online community may include:
1) a trigger event that begins an election for one or more leaders of the community or rules for codification,
2) non-equal voting power per user based upon a number of points that a user has accumulated in the online community, so certain users may have more votes or less votes than others,
3) an algorithmic selection of nominees for an election and/or an algorithmic selection of officials, and/or
4) an algorithmic selection of rules for vote and/or an algorithmic selection of rules to be codified.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

FIG. 1 depicts one embodiment of a network topology for self-governance in an online-community

FIG. 2 depicts one embodiment of a network topology for a self-governing online community.

FIG. 3 depicts an embodiment of a method for implementing a rule associated with an online community.

FIG. 4 depicts an embodiment of a method for implementing a rule associated with an online community.

FIG. 5 depicts an embodiment of a method for implementing a rule associated with an online community.

FIG. 6 depicts an embodiment of a method for implementing an election for an administrator associated with an online community.

FIG. 7 depicts an embodiment of a method for implementing an election for an administrator associated with an online community.

FIG. 8 depicts an embodiment of a method for implementing an election for an administrator associated with an online community.

FIG. 9 is one embodiment of an interface identifying candidates for an election.

FIG. 10 is one embodiment of an interface identifying a set of rules that may be voted upon.

FIG. 11 is one embodiment of an interface identifying punishments if a rule is broken.

FIG. 12 illustrates a system configured to provide an online community to users, in an embodiment.

FIGS. 13-15 illustrate methods for self-governing online communities, in embodiments.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

It should be appreciated that although modules may be illustrated as being implemented within a single processing unit, in implementations in which multiple processing units are used, one or more of the modules may be implemented remotely from the other modules. The description of the functionality provided by the different modules is for illustrative purposes, and is not intended to be limiting, as any of the modules may provide more or less functionality than is described. For example, one or more of modules may be eliminated, and some or all of its functionality may be provided by the other modules. As another example, a processor may be configured to execute one or more additional modules that may perform some or all of the functionality attributed to one of the modules described below.

Embodiments as disclosed below relate to systems and methods for self-organization and self-governance of an online community such as a social network, where trigger events may result in an election or new rule as decided via a democratic process by the online community. A democratic process, as used herein, merely refers to voting by users who will be affected by the results of the election. It does not imply one-to-one voting (different users may have different vote weights) or any traditional democratic process.

In embodiments, a trigger may be member or administrator initiated, or automatically triggered by a metric such as time or population. Members of the online community may be nominated for an election by other members or an algorithm or by themselves, nominees may be circulated for endorsements, and nominees who fail to get sufficient endorsements may be removed from the potential candidates for an election. Voting for the potential candidates or rules for the online community may be completed based on any type of voting or an algorithm that may select the winning candidate or new rule.

Algorithms may be based on characteristics of the online community and assumptions made regarding the suitability of different rules or administrators for communities having different characteristics. For example, an algorithm might determine that a rule requiring registration is suitable for a community once it has grown over a certain population. An algorithm might determine that a community in which a certain percentage of text constitutes swear words or otherwise adult or obscene words is an adult-oriented community and thus a rule permitting swearing is suitable. For example in the case where a community includes an online forum having various sub-forums, a member interacting most frequently in a certain sub-forum might be algorithmically selected as a moderator or other administrator of that sub-forum. The assumptions on which such algorithms are based may be set by default, may be updated based on information received about various online communities and their characteristics and rules, and/or may be set and/or modified by founders, administrators, and/or some or all members of the online community when the online community is established and/or later.

A voting period may end in a variety of fashions, and after the selection is finalized winning candidates may be given administrative responsibilities for the online community for defining user permissions/privileges, such as the ability to suspend members, edit content, etc. of the online community. A similar process may be completed for the enactment of rules. After rule selection is finalized, approved rules may be implemented, either algorithmically or by proclamation and/or enforcement by administrators. For example, if a rule against swear words is approved, it may be implemented algorithmically such that swear words are automatically filtered and no direct action then needs to be taken by administrators to enforce the rule.

Initial rules and/or administrators may be set when an online community is first created or when a system for rules and/or administrators is put into place subsequent to an online community's creation. Initial rules and/or administrators may be selected by founders of the online community and/or by existing administrators or other persons in a position of authority. Selectors may be guided at least partially through a selection process by a wizard or similar, recommending or automatically putting in place certain rules and/or administrators based on a purpose and/or other characteristics of the online community. Such initially set rules may particularly include voting rules, triggers, administrator positions, and/or selection algorithms.

Before turning to specific embodiments as disclosed herein, a general discussion of a system to self-govern an online-community may prove useful.

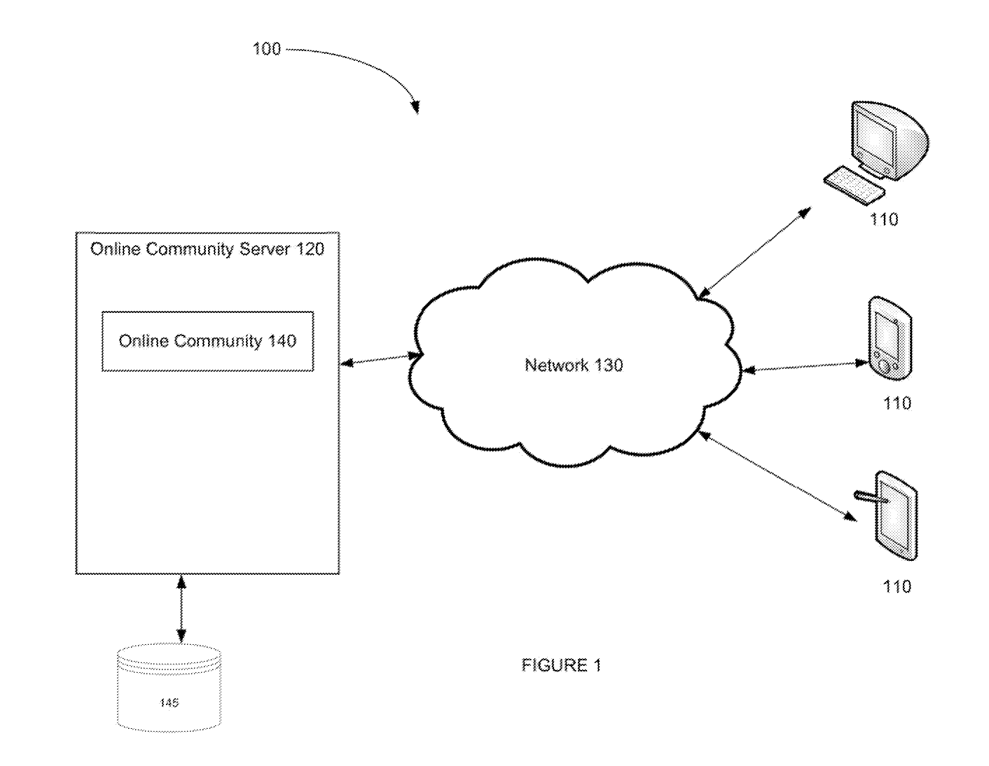

FIG. 1 depicts one embodiment of network topology 100 for self-governance of an online-community. The topology 100 includes one or more client devices 110 connected to an online community server 120 over a network 130.

The network 130 may be a wired or wireless network such as the Internet, an intranet, a LAN, a WAN, a cellular network or another type of network. It will be understood that network 130 may be a combination of multiple different kinds of wired or wireless networks.

Online community server 120 may be a server or server cluster, virtual server, or the cloud, that is capable of supporting an online community 140, and may be communicatively coupled to client devices 110 via network 130. Online community server 120 may include a processor, memory, and interface configured to communicate data to and from client devices 110.

Online community 140 may be associated with any genre, topic or sub-topic and include groups of users interested in subject matter associated with the group and may be a website by itself or be a subset of a website. One skilled in the art, will realize that online community 140 may not be associated with a particular topic or subject and have members that are not associated with each other.

Online community 140 may include repository 145. Repository 145 may be a file store, memory or some other storage medium configured to store components (e.g. modules, instructions, etc.) to support online community 140. For example, repository 145 may include data associated with identification and password associated with a user on online community 140, as well as the user's preferences and/or privileges on online community. In one embodiment, repository 145 stores content, posts, comments and any other forms of data for online community 140.

Client devices 110 may be smart phones, tablets, laptop computers, desktop computers, personal data assistants (PDA) or any other type of device that can process instructions and connect to network 130 or one or more portions of network 130. Client devices 110 may have a processor, memory, display or interface configured to receive inputs from an end user. A user using client device 110 may communicate content such as an article, post, image, movie, audio recording, etc. that may stored within repository 145 and be rendered on an interface for online community 140 so other members associated with online community 140 may view the content. In further embodiments, members of online community 140 may write comments, edit, re-publish or perform other actions associated with the content for online community 140.

As discussed above, the increasing prevalence of online communities has led to a need for systems and methods that allow users to self-organize and build self-governed online communities where the leaders and rules may be elected or chosen by the members of the online community via a democratic process.

In one embodiment, members of online community 140 may self govern the community via electing members to positions of responsibility (referred to herein after as “administrators”) and enacting rules.

Elections may be triggered based on factors such as time, population, member and/or administrator demand, etc. The positions of responsibility may be defined by their permissions associated with online community 140, such as the ability to suspend members, edit content, etc.

To nominate members for an election for administrators, online community 140 may utilize an algorithmic process, a vote by the members of the online community, or a combination of the two. Subsequently, there may be an endorsement stage if there are too many nominees to be an administrator or for any other desired reason. Where multiple administrators are selected in a single election, there may be individual, differentiated administrator positions for which nominees run (e.g. President, Treasurer), or there may be a pool of identical administrator positions where each nominee is seeking one of the pool of positions, or a combination of these two options (some pooled and some differentiated positions). Where there are differentiated positions, endorsement may be triggered for those positions having too many nominees, and not for other positions. Similarly, at other stages of the process, where multiple differentiated positions or rules are being filled or approved together, different determinations may be arrived at with respect to different positions/rules. For example, nominations may be taken from users or only from administrators for some positions and generated algorithmically for others, some rules may be voted on (in some embodiments or circumstances only by administrators) and others may be automatically implemented by algorithm, etc. The endorsement stage may end once a certain period of time has elapsed, a percentage or number of members have voted, etc., and certain nominees who fail to get sufficient endorsements may be removed from the elections.

Based on the remaining nominees a voting stage may begin to elect the administrator. The voting may be based on any type of voting, including weighted voting where some members may get more votes than others (and some members may get no votes). The voting stage may end after a certain period of time, a certain percentage of votes are cast, or any other known way to end an election. When voting is finalized, the results are implemented, which may include the results being posted to an informational section of the website (on, e.g., an “administrators” or “rules” page), badging/recognition (e.g. administrator badges and/or titles applied to elected users in the website forum), and/or corresponding permissions being assigned to the winning members. Instead of voting, the results may in some embodiments and some circumstances be determined algorithmically or only by administrators.

Voting for rules affecting user permissions for online community 140 may be conducted in a similar fashion. In one embodiment, members may express their desire for a rule change by creating a rule on client device 110 via a form on online community 140 or via any other known mechanism to create a rule. A member may then communicate their rule to online community 140 to submit it for vote during any point in a voting or rule cycle. If the rule gets enough votes to pass by the end of that cycle, as determined by an algorithm, vote, or a combination, then the submitted vote will become an implemented, enforceable rule. Rules may, depending on the type of rule, community preferences, etc., be enforced in various fashions once adopted. They may be enforced automatically and algorithmically (such as swear word filters), or may be posted to an informational area with community members expected to enforce the rule, or the task of enforcement may be assigned to some administrator(s) or other member(s).

In one embodiment, if members of online community 140 disapprove of a current rule or want to support a current rule to ensure it remains, the members may down vote or up vote that rule on an interface of online community 140 via client device 110. Depending on the amount of up votes or down votes an associated rule obtains during a certain period, that rule will either remain or disappear. In other words, in one embodiment there may be a set of rules, and some of the rules may already be implemented, while others may be being proposed. During a rule voting cycle, members vote on both types of rules, either up and down, and the results of this vote determine what the rules will be upon the conclusion of the cycle.

One skilled in the art will appreciate that that the algorithm for getting rid of a rule may not be the same as the algorithm for determining a new rule. For example, getting rid of an existing rule may require >60% of votes cast to be in favor of removing the rule, but a new vote may only need 50% of votes to be in favor of enactment to pass.

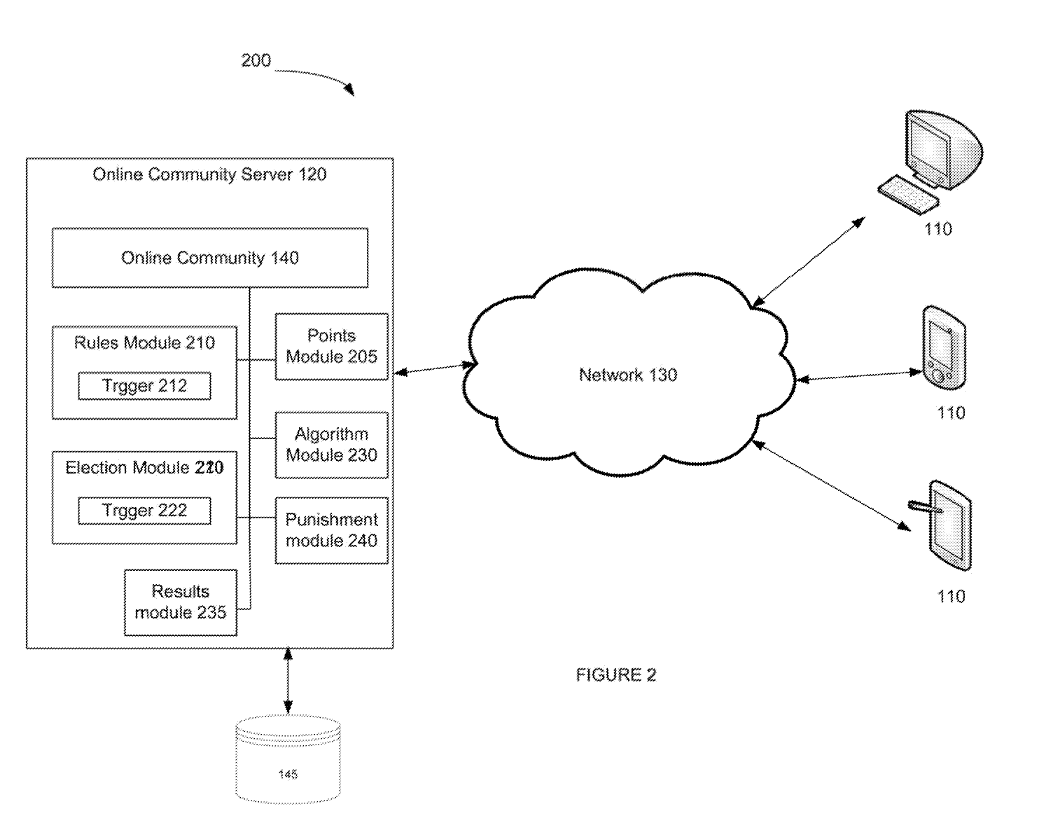

Moving now to FIG. 2, one embodiment of a network topology 200 for a self-governing online community is depicted. Certain elements of topology 200 may be similar to those depicted in FIG. 1, therefore another description of these elements is omitted for the sake of brevity.

As depicted in FIG. 2, online community server 120 may also include points module 205, rules module 210, election module 220, algorithm module 230, results module 235 and punishment module 240 that are bi-directionally communicatively coupled to online community 140.

Points module 205 may be configured to determine a number of points associated with a member of online community 140, and the points may be associated with a level of involvement of the member in online community 140. Points module 205 rewards members for their contributions to online community 140 with more votes. Therefore, certain members may have more or less votes than other members on the online community 140 based on their contributions to online community 140.

The points associated with members may be used for weighted voting for elections and rules. In an embodiment, members of online community 140 may earn points for various activities they complete that are associated with online community 140. For example, a member may earn points for posting content to online community 140, hosting an online seminar for online community 140, peer approvals on online community 140, seniority on online community 140, editing content on online community 140, commenting on content on online community 140, etc. In various embodiments, points may be earned based both on amount of involvement and quality of involvement, so for example a comment that receives many approvals from other members may receive more points for the posting member than a comment that receives fewer approvals, and a comment that receives many disapprovals may earn no or even negative points for the posting member.

Points module 205 may allocate weighted votes to members associated with the number of points the member has. In one embodiment, if a member obtains fifty points, points module 205 will allocate two votes to the member instead of one or for every certain number of points a member obtains, the member may be allocated an additional vote. The number of votes allocated may be related to the number of member points in any known fashion, for example the number of votes may be a rounded square root or cube root of the number of point, such that at higher point levels more points are required to obtain an additional vote. A certain number of points may also be required to earn even a single vote, or a negative amount of points may eliminate a member's vote. In some embodiments, points may determine other privileges of members in addition to or instead of number of votes, such as access to various subforums or other network contents, and may be a basis for algorithmic determination of administrators (e.g. members with the highest number of points are automatically selected as administrators).

Rules module 210 may be configured to determine a set of rules governing conduct for members utilizing online community 140. The individual rules may determine different privileges for the members of online community 140. These permissions are not necessarily algorithmic or technical, and may be for example whether members are allowed to discuss certain topics, etc.

The set of rules may include rules that govern the conversations and content, such as what members may say, link to, or post to on online community 140. In one embodiment, members may be able to vote to allow or disallow swearing in posts, comments, chats, etc. that are made on online community 140.

The set of rules may also include rules that may affect the settings of the online community. These types of rules may be initiated when the online community 140 is being created, such as who can join, to what extent the online community 140 is visible to searches, and what content may be viewable by the public. For example, in one embodiment members may be able to change society settings for online community 140, such as if the community is invite only or open to the public, chat or posting rate limits (how frequently a member can post a link, comment, and/or chat), and aesthetics of online community 140.

The set of rules may include rules that affect the democratic process, such as rules that determine how points are received for the online community 140 as well as the procedures for voting on rules, punishments, and elections, when elections are held, who can run, etc.

Rules module 210 may include a rules trigger 212 to determine if a rule or a set of rules should be voted upon or automatically codified. Rules trigger 212 may be based on at least a rules time period and/or a rules population of the online community 140. Rules trigger 112 may determine when a rule would come up for vote, and when these votes would be tabulated in order to codify a new rule.

In one embodiment, a rules time period may indicate that a rule or set of rules should be voted upon periodically and/or that votes for desired rule changes and/or new rules should be tabulated after a period of time has lapsed.

In one embodiment, a rules population may be a threshold associated with a number of members or a percentage of members desiring a rules change for online community 140. If a predetermined, desired or required number of members or percentage of users in online community 140 above the threshold express a desire for a rule change, than this may trigger a vote for a rule change. For example, in one embodiment, if one hundred users of online community 140 express a desire for a rule change then the rule would come up for a vote.

Election module 220 may be configured to determine a set of rules governing elections of administrators for online community 140.

Election module 220 may include an election trigger 222 to determine if an election and/or nomination for an administrator or a plurality of administrators should be held. Election trigger 222 may be based on at least an election time period and/or an election population of the online community 140. In one embodiment election trigger 222 may be associated with a recall election that may be triggered by an elected official quitting, dying, or being sufficiently down-voted during her time in office. In one embodiment, if either her or her official actions are associated with down votes that exceed a threshold during a period in which she holds office, then a recall election may be held to replace her.

In one embodiment, an election time period may be every sixth months or any other desired or required time period. Upon the election time period lapsing, an election for an administrator associated with the election time period may be held automatically. An election population may be a trigger associated with an administrative position. If the community's population reaches or exceeds an election population threshold, an election for a particular office or offices may be initiated and/or an existing, on-going election may be tabulated. Therefore, if the population reaches an election population threshold, election trigger 222 may automatically initiate nominations or elections and/or finalize ongoing elections.

One skilled in the art will appreciate election trigger 222 may be based on additional factors. In another embodiment, election trigger 222 may trigger an election if there is an office vacancy, such as if an office holder resigns. In one embodiment, if no nominees garnered enough votes to satisfy algorithmic and/or procedural requirements to achieve office, that could also trigger a new election in order to fulfill those requirements.

In one embodiment, online community 140 may use an algorithm module 230 to, for example, automatically determine who is a nominee for an office, or to select/elect an administrator or rule without a vote. Algorithm module 230 may use algorithms to put a rule up to vote or decide if a rule will be automatically implemented, to determine who is a nominee for an administrative position, and/or to select the administrator based on any number of inputs including the number of points a user has, how long a user has been a member of online community 140, the number of other users of online community 140 who endorse a user, population and age of the online community 140, number of posts made in the online community 140, number of comments made in the online community 140, number of people that leave the online community 140, the number of infractions or number of rules broken within an online community 140, etc.

In an embodiment, algorithm module 230 may determine that a certain number of members, for example the top five members in terms of points are automatically nominated for office.

In another embodiment, algorithm module 230 may determine that a member with the most points is automatically elected to be an administrator.

In one embodiment, algorithm module 230 may also be configured to determine if a rule will be put up to vote or if a rule will be automatically implemented. For example, algorithm module 230 may be configured to determine if the population reaches a threshold or if a threshold number of new users are added to online community 140 that a rule may be automatically put up for a vote or a rule may be automatically implemented.

Results module 235 may be configured to automatically implement the results of an election, whether algorithmic or not, at the conclusion or at any desired period after the conclusion of either type of event.

In association with an election, results module 235 may be configured to update relevant informational pages, member permissions and all pertinent web pages to reflect the results of the election or vote on a rule, and enact their intended consequences on online community 140. In one embodiment, results module 235 may display profiles and/or names of the members who won an election on a webpage associated with online community 140. In another embodiment, results module 235 may implement the different member's permissions for a member who won and/or lost an election for an administrative office on online community 140.

In association with a vote for a rule, results module 235 may be configured to automatically update informational pages displaying the results on the vote for the rule, an updated rules list, and any contextual menus or enforcement pages that such a rule would need to be displayed, or otherwise interact with on online community 140. In another embodiment, results module 235 may provide updates to an online community that as a result of a vote or algorithmic decision rules were eliminated and are no longer in effect for the online community.

Punishment module 240 may implement actions if a member of online community 140 breaks one of the rules. In one embodiment, punishment module 240 may deduct a number of points from a member, which may change the standing and rights and/or permissions of the member, remove rights/permissions/office of the member, suspend or expulse the member from the society, shame the member in the form of some graphical, numerical, and/or text-based identifier of their offense (for example to be viewed in their profile or alongside their posts), or implement any of the punishments at the website-wide or network-wide level instead of just the society-wide level.

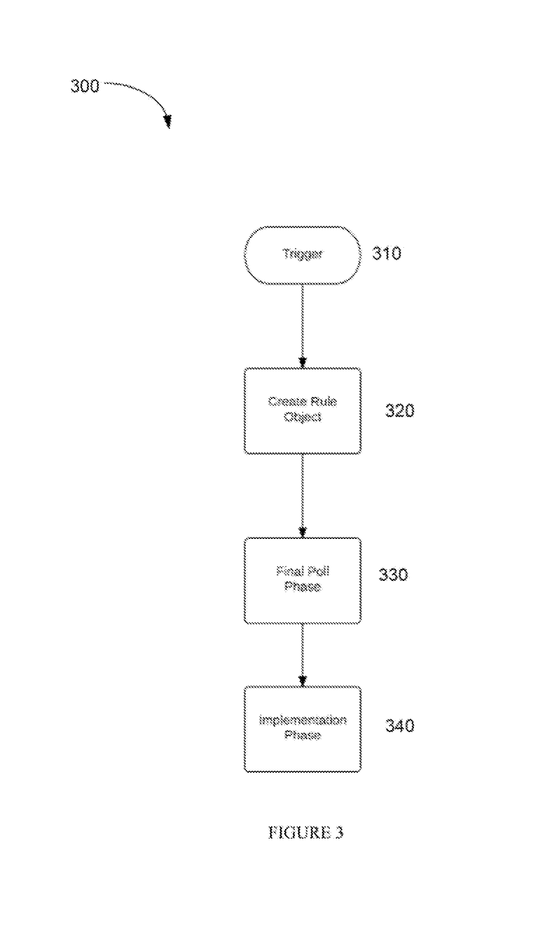

FIG. 3 depicts an embodiment of a method 300 for implementing a rule associated with an online community.

At step 310, an event may trigger an action associated with a rule, such as an enactment of or vote on a rule. The trigger may be associated with a time period, a population size of the online community, member demand etc.

At step 320, a rule object may be created in a data store for voting based on the trigger. For example, upon the online community having a population size above a certain threshold, it may be desired to amend members permissions for the online community or create a rule requiring members to login or register with the online community before commenting on content associated with the online community. Therefore, based on the trigger a new rule object (e.g. a registration requirement) may be created. The rule object may be updated during voting to reflect votes in favor of or against the new rule.

At step 330, voting may begin for the rule on the online community. The voting may be any type of voting, including weighted voting where some members may get more votes than others, some members are able to vote and others are not, or all members may have the same number of votes. Voting may end after a certain period of time elapses, after a certain percentage of votes for the online community have been cast, after a certain number of users for the online community have cast their vote, any combination of the above, etc.

At step 340, voting may be finalized for the rule by tallying the votes cast, and the results of the rule may be implemented on the online community. One skilled in the art will appreciate that upon voting being finalized, the number of votes cast may be tallied based upon the number of votes associated with each member and not the number of members who voted, because each member may have a different number of votes.

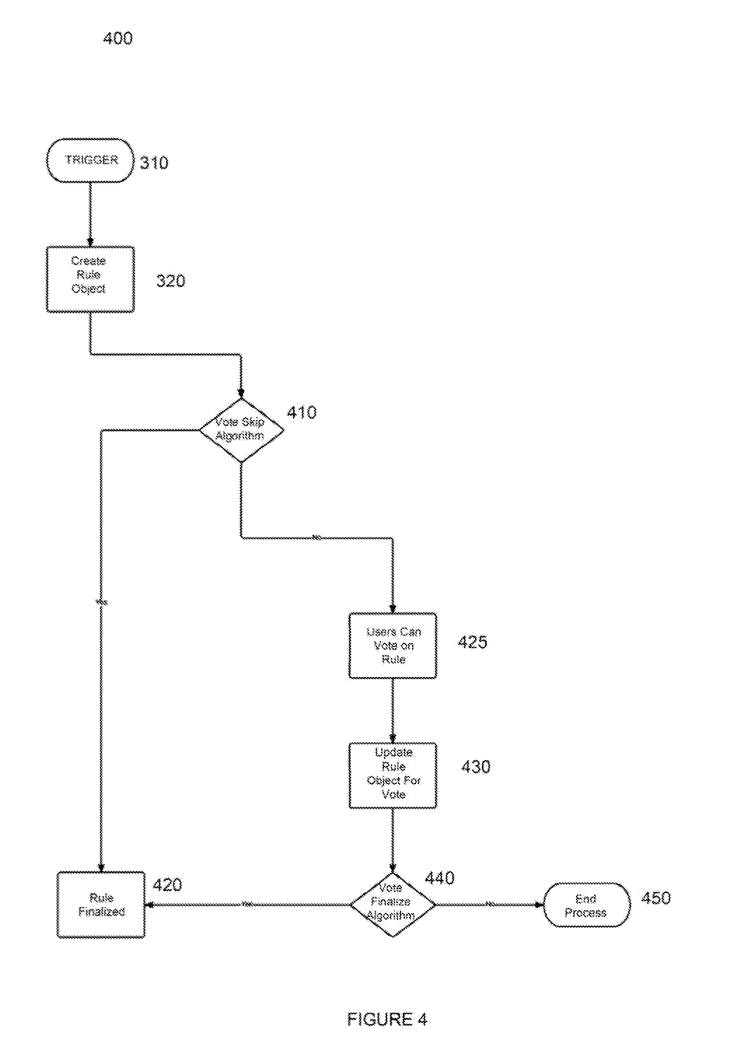

FIG. 4 depicts an embodiment of a method 400 for implementing a rule associated with an online community. Steps 310 and 320 in method 400 may be substantially the same as discussed above in FIG. 3, and for the sake of brevity another description of these steps is omitted.

At step 410, it may be determined if the rule includes data indicating that the rule should be voted upon by users of the online community or not. If at step 410, it is determined that the rule includes data indicating that the rule should not be voted upon, then at step 420 the rule may be finalized and automatically implemented in the online community or may be discarded.

On the other hand, if at step 410 it is determined that the rule includes data indicating that the rule should be voted upon, then at step 425 an entry associated with the rule is created in a database/cache to track which members having associated votes have voted for a rule.

At step 430, voting may begin for the rule on the online community to determine whether to enact the rule or not. Members may be able to vote using any type of voting, including weighted voting where some users may get more votes than other users, some users are able to vote and others are not, or all voters may have the same number of votes. After a member votes upon the rule, the database/cache associated with the rule may be updated to account for the member placing a vote.

At step 440, voting may end and be finalized for the rule, and it may be determined if the rule is to be enacted or not. Voting may end after a certain period of time elapses, after a certain percentage of votes for the online community have been cast, after a certain number of users for the online community have cast their vote, any combination of the above, etc. At step 440 if the rule did not obtain enough votes or a high enough percentage of votes cast to be enacted, then at step 450 the process may end and the rule may not be implemented.

At step 440, if the rule obtained enough votes or a high enough percentage of votes cast to be enacted, then at step 420 the results of the rule may be implemented on the online community.

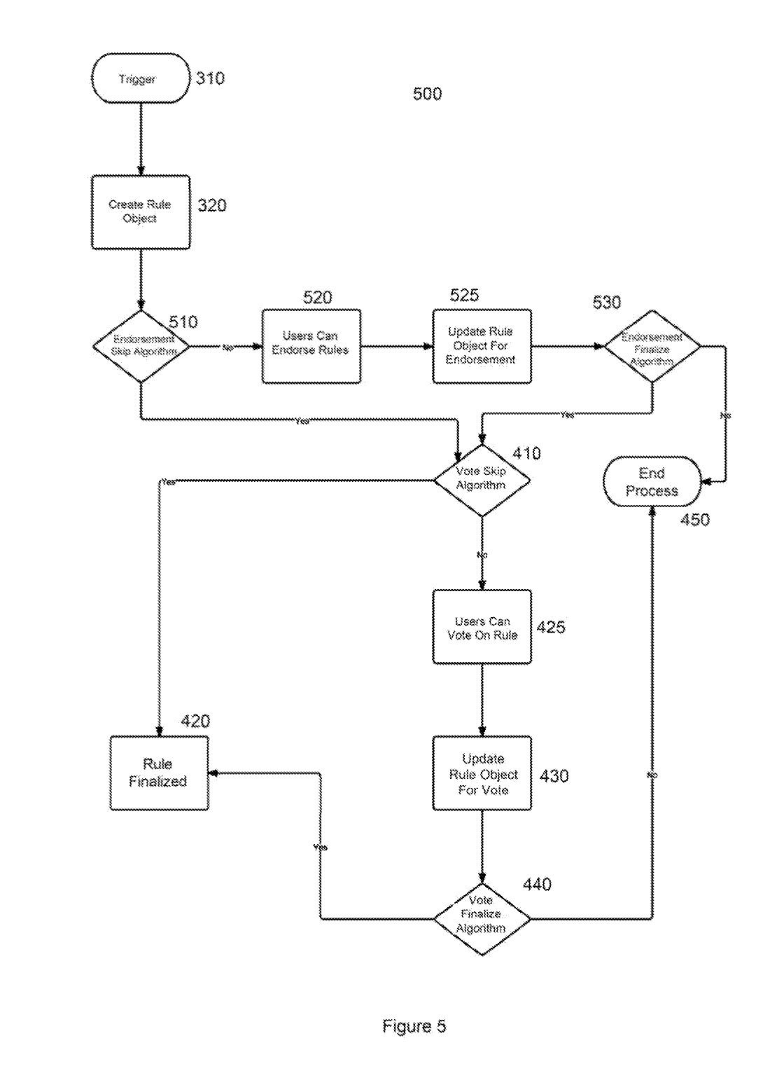

FIG. 5 depicts an embodiment of a method 500 for implementing a rule associated with an online community. Steps 310 and 320, in method 500 may be substantially the same as discussed above in FIG. 3 and steps 410, 420, 425, 430, 440 and 450 may be substantially the same as discussed above in FIG. 4, and for the sake of brevity another description of these steps is omitted.

At step 510, it may be determined if the rule has data associated with it identifying whether the rule requires endorsements before being put up for a vote. The data identifying whether the rule requires endorsements may be stored as metadata associated with the rule or via any other known ways of associating data. If it is determined at step 510 that the rule does not require endorsements, then the process may continue to step 410 as discussed above in FIG. 4.

If at step 510 it is determined that the rule requires endorsements before being put up for a vote, then at step 520 members may vote to endorse a rule.

At step 520, members may identify whether they desire to vote upon the rule, nominating the rule or set of rules to be voted upon. In one embodiment, the number of endorsements desired or required for a rule to be put up for vote may be fewer than a number of votes required for a rule to be enacted or codified. For example, endorsement by a certain percentage of members, e.g. 25%, may be required, or the top five (or ten, or n) endorsed rules may be voted on. Step 520 may end once a certain period of time has lapsed, a percentage of members have voted, etc., and certain nominees that fail to get sufficient endorsements may be removed from the elections.

At step 525, data associated with the rule may be updated to identify what members and their associated votes endorsed what nominees.

At step 530, a number of endorsements associated with a vote may be tabulated. If the number of endorsements is lower than an endorsement threshold associated with a desired or required number of endorsements necessary for a rule to be voted upon, the rule may be discarded at step 450, and the process may be ended. On the other hand, if at step 530 the rule had enough endorsements greater than the endorsement threshold, then the process may continue to step 410 where the rule may be automatically codified or voted upon.

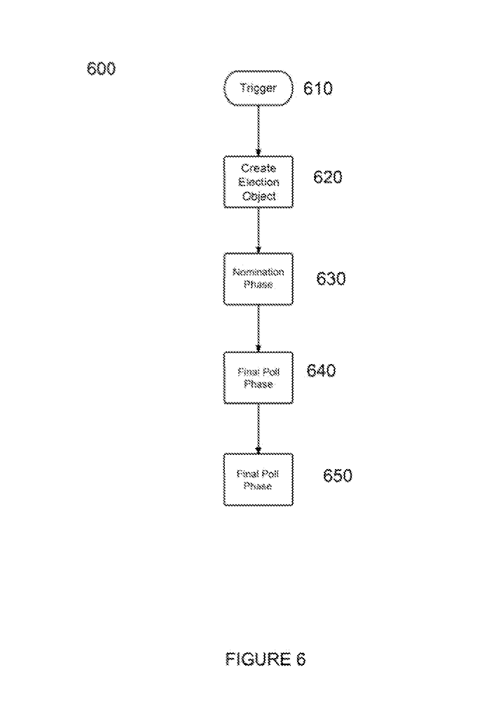

FIG. 6 depicts an embodiment of a method 600 for implementing an election for an administrator associated with an online community.

At step 610, an event may trigger an action associated with an election, such as to nominate or vote for an administrator. The trigger may be associated with a time period, a population size of the online community, member demand etc.

At step 620, an election for the administrator may be created based on the trigger. For example, after a lapse of a certain period of time, it may be desired to have a re-election for administrators for the online community.

At step 630, members for the online community may nominate themselves or other members for the election to be an administrator. In other embodiments, by way of example, an algorithmic process may be used to select the nominees for the elections, or only existing administrators may be allowed to nominate members for the election, or a combination of an algorithmic and voting process may be used to select the nominees for an election. In one embodiment, nominees may be required to be endorsed by a certain number or percentage of the members to be selected as nominees, or the members with the most endorsements may be nominated. Step 630 may end upon a certain period of time having elapsed, a percentage of members having voted, etc., and certain nominees who fail to get sufficient endorsements may be removed from the elections.

At step 640, the nominees for an administrator positions may be voted upon to elect the administrator. The voting may be based on any type of voting including weighted voting where some members may get more votes than others. Step 640 may end after a certain period of time, a certain percentage of votes are cast, or any other known way to end an election.

At step 650, voting is finalized and the results of the election are implemented, with corresponding permissions being assigned to the winning members, election results posted to an informational page/location, and/or identifiers being added to winning members.

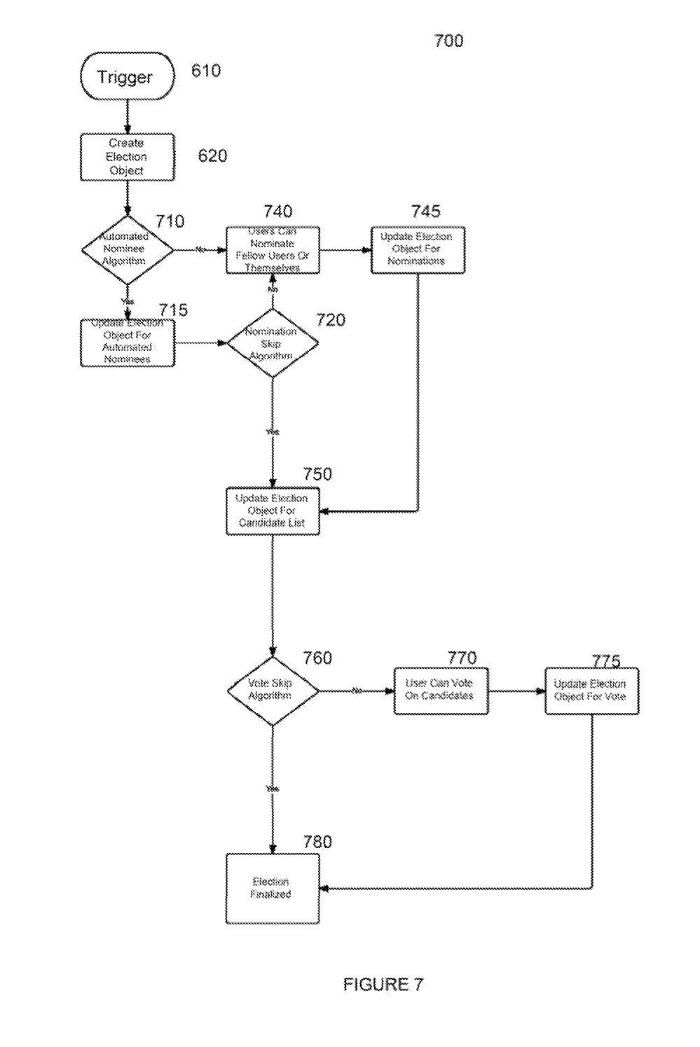

FIG. 7 depicts an embodiment of a method 700 for implementing an election for an administrator associated with an online community. Steps 610 and 620 in method 600 may be substantially the same as discussed above in FIG. 7, and for the sake of brevity another description of these steps is omitted.

At step 710 it may be determined if a rule requires nominees for the election to be automatically selected via an algorithm or not. If it is determined at step 710, that the nominees will be automatically selected for an election, then an algorithm will determine that certain members should automatically be nominees for an election, for example the members with the highest number of points for the online community may be automatically nominated for office, and at step 715 a database or cache associated with an election may be updated to identify which candidates are nominated for the election via the algorithmic process. The database/cache may include information associated with which nominees have been selected and a certain number of votes associated with each nominee.

At step 730, it may be determined if nominees may be selected by other members and/or themselves (or, e.g., only by existing administrators). If it is determined at step 730 that users can nominate themselves or other members for an election, or if it is determined at step 710 that an algorithm may not determine the nominees for an election, then at step 740 members may nominate themselves or other members for an election.

At step 745, a database or cache associated with an election may be updated to identify which candidates are nominated for the election. The database/cache may include information associated with which members have nominated whom.

At step 750, a candidate list for an election may be updated to include nominees that are selected by the members (or, e.g. only by existing administrators or some other select group) and/or automatically via an algorithmic process.

At step 760, it may be determined if the election includes data indicating that the election should be voted upon by members of the online community or not. If not, the administrators may still be selected algorithmically, without a vote.

If at step 760 it is determined that the election includes data indicating that the nominees for the election should be voted upon, then at step 770 members may vote to elect a nominee to be an administrator. At step 770, voting may begin for the administrator where members may be able to vote using any type of voting, including weighted voting where some users may get more votes than other users, some users are able to vote and others are not, or all voters may have the same number of votes. Voting may end after a certain period of time elapses, after a certain percentage of votes for the online community have been cast, after a certain number of users for the online community have cast their vote, any combination of the above, etc.

At 775, after a member votes for a candidate(s), the database/cache associated with the election may be updated to account for the member placing a vote, and the number of votes associated with the member.

At step 780, voting may be finalized for the election, and it may be determined what nominees are to be elected. In one embodiment, the nominee with the highest number of votes may be elected for the administrative position associated with the election. The elected nominees may be granted appropriate permissions, election results may be posted in an information location, and badges/identifiers may be established for the elected nominees, etc.

Returning to step 760, if it is determined that the election includes data indicating that the election should not be voted upon, then at step 780 the election may be finalized via an algorithmic process where the nominee with the most points is automatically selected to be an administrator. Alternatively, the results may be discarded, a revote may be initiated, administrators may be selected based on other criteria, etc. In another embodiment, if there are multiple administrative offices to be held, then the members with the most points may automatically each be selected to one of the administrative positions. Then, at step 780, after the selection is finalized, winning candidates may be given administrative responsibilities for the online community for defining user permissions/privileges, such as the ability to suspend members, edit content, etc. of the online community.

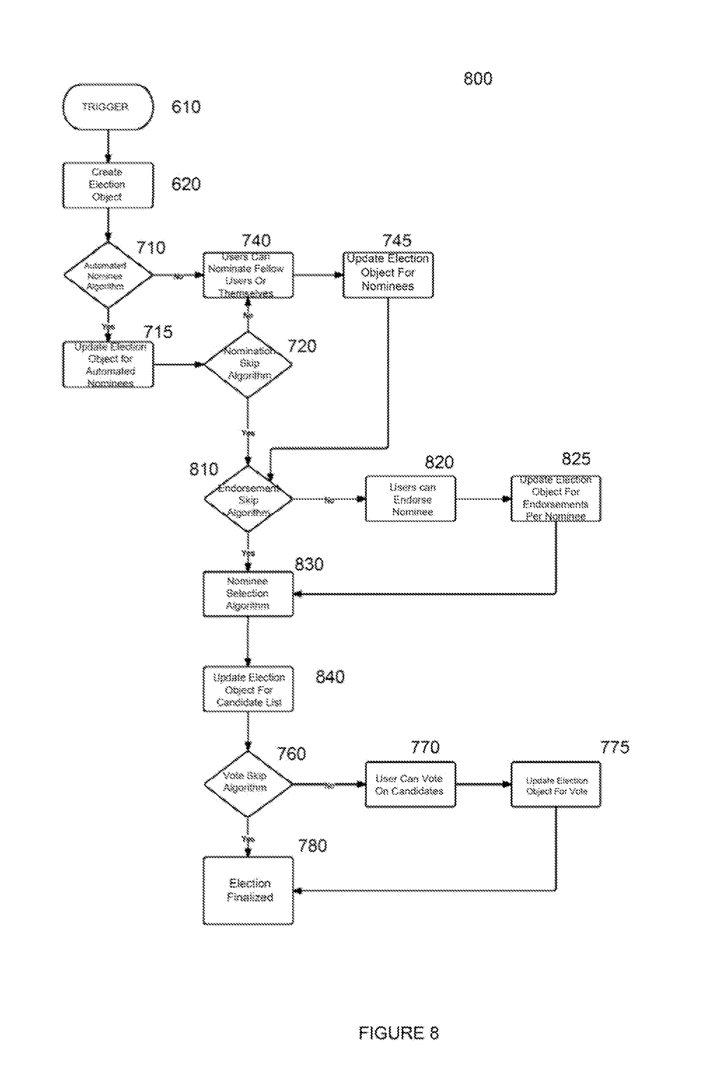

FIG. 8 depicts an embodiment of a method 800 for implementing an election for an administrator associated with an online community. Steps 610 and 620, in method 600 may be substantially the same as discussed above in FIG. 6, and steps 710-740 and 760-780 may be substantially the same as discussed above in FIG. 7, and for the sake of brevity another description of these steps is omitted.

After nominees for the election have been selected either via an automatic process, member vote, or a combination of both, then at step 810, it may be determined whether the election requires nominees to obtain endorsements from members. If not, the process proceeds directly to a nominee selection algorithm 830.

If it is determined at step 810 that nominees are required to get endorsed by a certain number of or percentage of members, then at step 820 members may endorse a nominee. Step 820 may end once a certain period of time has lapsed, a percentage of members have voted, etc.

At 825, after a member endorsees a nominee, the database/cache associated with the election may be updated to account for the member making the endorsement, and the number of endorsement votes associated with the member (in some embodiments certain members' endorsements may count more than others, based e.g. on points as in voting).

At step 830, after members have endorsed nominees, a nominee selection algorithm may select what nominees should be included in the candidate list for the election. In some embodiments, the nominee selection algorithm may be based on the number of endorsements received from members at step 820, the number of points associated with a nominee, or a combination of both. In other embodiments, various other meritocratic criteria may be utilized, such as number of posts or upvotes, date of joining, etc. At step 830, if a nomine fails to get sufficient endorsements, then that nominee may be removed from the elections.

At step 840, a candidate list may be updated to include the remaining candidates for the election, where the nominees on the candidate lists may be elected for an administrative position based on a vote, an algorithmic process or a combination.

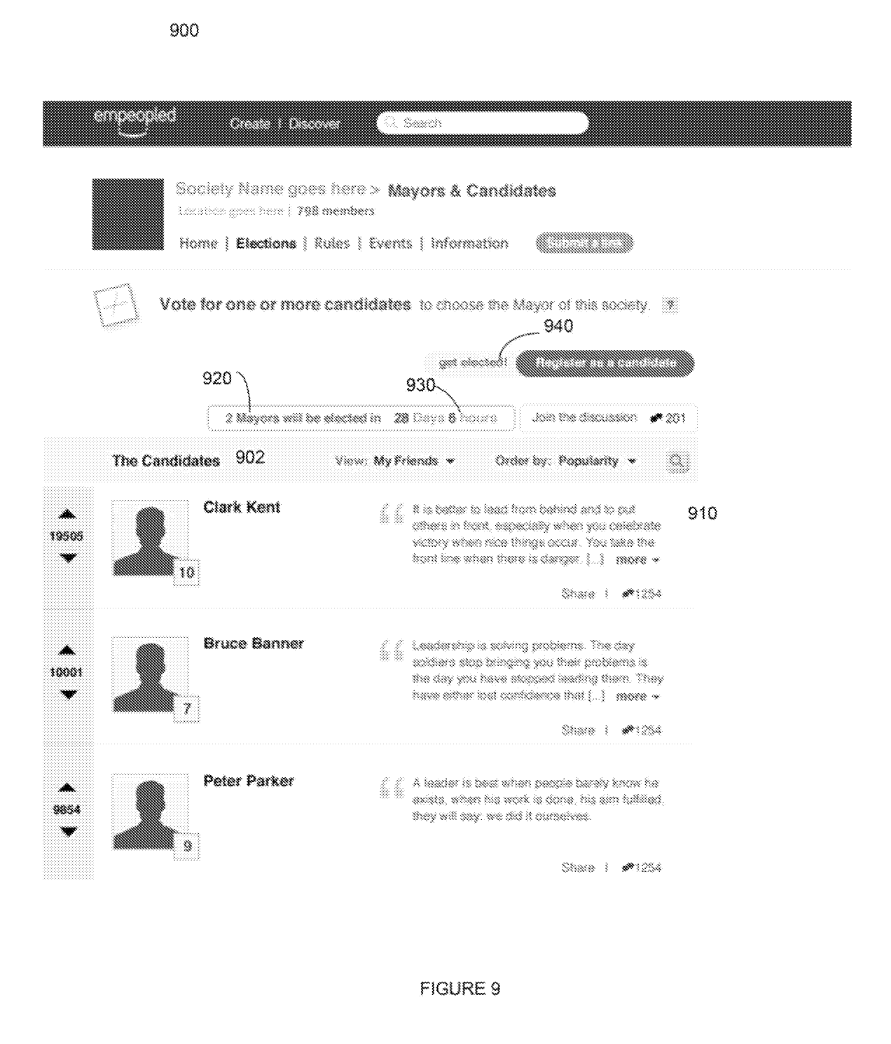

FIG. 9 is one embodiment of an interface 900 identifying candidates for an election. Interface 900 may include a list of candidates 902 and their opinions 910 for the election, the number of administrator positions 920 being elected, and a time period 930 associated with the election. Further, interface 900 may include a button 940 where members may register as a candidate for the election.

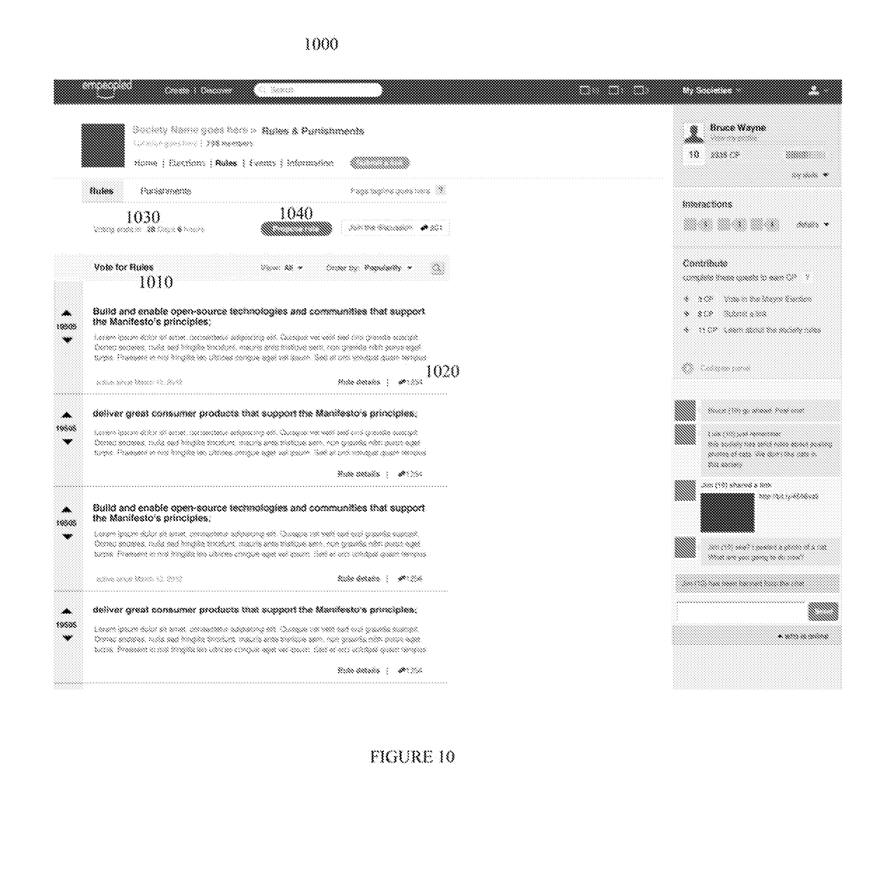

FIG. 10 is one embodiment of an interface 1000 identifying a set of rules 1010 that may be voted upon. Each of the set of rules 1010 may include a description of the rule 1020 and a date associated with the rule 1030. Interface 1000 may also include a button 1040 where members may propose a rule.

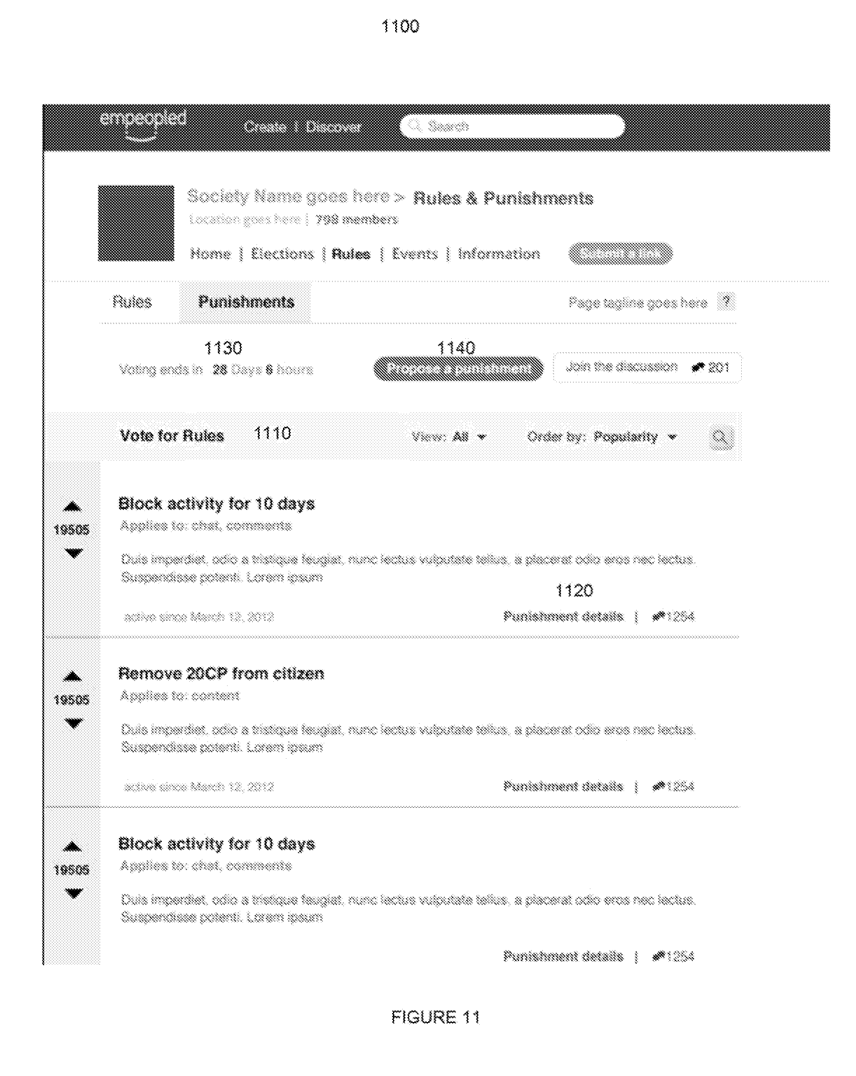

FIG. 11 is one embodiment of an interface 1100 identifying punishments 1110 if a rule is broken. Each of the set of punishments 1110 may include a description of the punishment 1120 and a date associated with the punishment as well as a time period 1130 after which voting will end. Interface 1000 may also include a button 1140 where members may propose a punishment if a rule is broken.

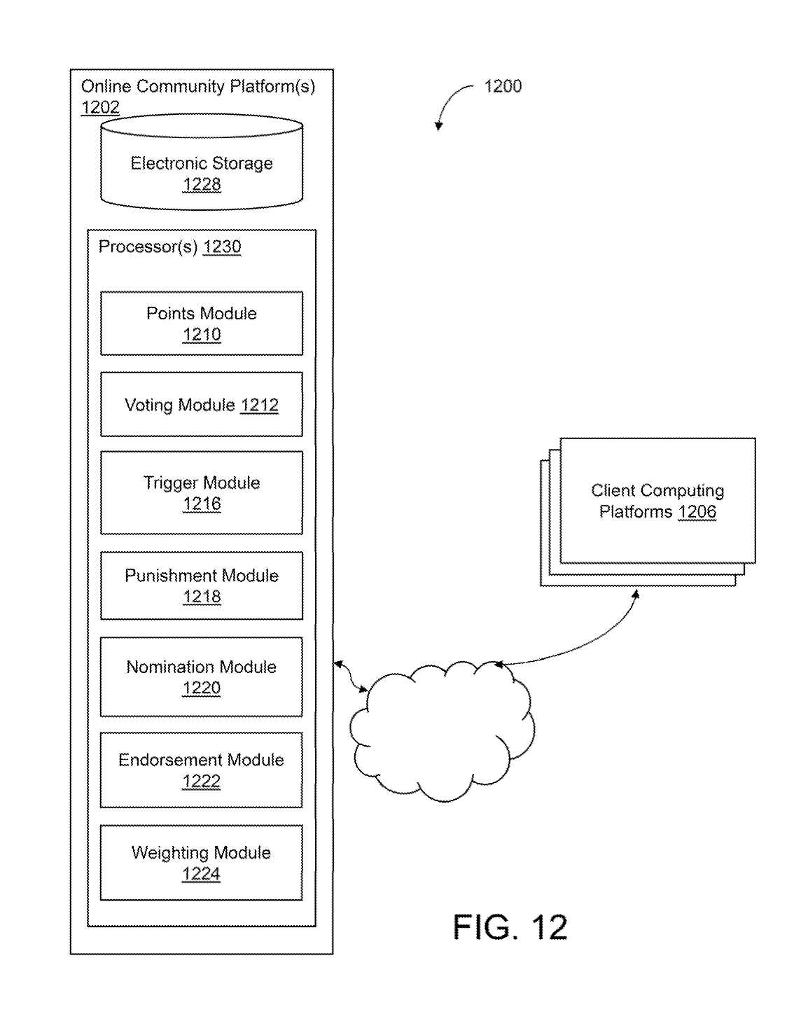

FIG. 12 illustrates a system 1200 configured to provide an online community to users, in an embodiment. Providing the online community may include hosting the online community over a network. Online community platform 1202 may be configured to communicate with one or more client computing platforms 1206 according to a client/server architecture. The users may access system 1200 via client computing platforms 1206.

System 1200 is only one example of a suitable computing environment and is not intended to suggest any limitation as to the scope of use or functionality of the features described herein. The online community platform 1202 is configured to host one or more online communities and execute one or more computer program modules. In implementations, online community platform 1202 may be configured to receive user requests to provide access to a plurality of online communities to users. The computer program modules may include one or more of a points module 1210, a voting module 1212, a trigger module 1216, a punishment module 1218, a nomination module 1220, an endorsement module 1222, and/or a weighting module 1224. As noted, the client computing platform(s) 1206 may include one or more computer program modules that are the same as or similar to the computer program modules of the online community platform(s) 1202 to facilitate providing the online community to the user.

Points module 1210 may be configured to determine points associated with members of an online community, based at least in part on the members' involvement in the online community. Voting module 1212 may be configured to conduct votes to determine at least one of administrators (or other governing members) of the online community and rules governing the online community. In other embodiments, the functionality of this module may be incorporated into modules responsible for determining the rules and/or members governing the online community. Votes may select new rules to be implemented and/or old rules to be discarded and/or select new administrators and/or existing administrators to be removed. Voting module may incorporate algorithms for nomination of rule/administrator candidates and/or may work in concert with algorithms incorporated into other modules or in an independent algorithm module which may at time determine administrators and/or rules without voting. Trigger module may be configured to trigger determinations by the rules module and/or election module regarding new rules and/or administrators. In other embodiments, triggering is internal to the rules and election modules and no separate module is needed. Punishment module 1218 may be configured to enforce rules in place for the online community. In other embodiments, the functions of punishment module 1218 may be internal to the rules module 1212. Nomination module 1220 may be configured to determine nominees, for example by soliciting and/or receiving nominations from members or by algorithm, for a vote initiated by voting module 1212. Endorsement module 1222 may be configured to determine endorsements for nominees, for example by soliciting and/or receiving endorsements from members, for a vote initiated by voting module 1212. Weighting module 1224 may be configured to weight and/or permit votes of the members of the online community based at least in part on the number of points associated with each member.

In some implementations, the online community platform 1202 and client computing platforms 1206 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 1202 and client computing platforms 1206 may be operatively linked via some other communication media.

A given client computing platform 1206 may include one or more processors configured to execute computer program modules. The computer program modules may be configured to enable an expert or user associated with the given client computing platform 1206 to interface with system 1200, and/or provide other functionality attributed herein to client computing platforms 1206. By way of non-limiting example, the given client computing platform 1206 may include one or more of a desktop computer, a laptop computer, a handheld computer, a tablet computing platform, a NetBook, a Smartphone, a gaming console, and/or other computing platforms.

Online community platform 1202 may include electronic storage 1228, one or more processors 1230, and/or other components. Online community platform 1202 may include communication lines, or ports to enable the exchange of information with a network and/or other computing platforms. Illustration of online community platform 1202 in FIG. 12 is not intended to be limiting. Online community platform 1202 may include a plurality of hardware, software, and/or firmware components operating together to provide the functionality attributed herein to online community platform 1202. For example, online community platform 1202 may be implemented by a cloud of computing platforms operating together as online community platform 1202.

Electronic storage 1228 may comprise non-transitory storage media that electronically stores information. The electronic storage media of electronic storage 1228 may include one or both of system storage that is provided integrally (i.e., substantially non-removable) with online community platform 1202 and/or removable storage that is removably connectable to online community platform 1202 via, for example, a port (e.g., a USB port, a firewire port, etc.) or a drive (e.g., a disk drive, etc.). Electronic storage 1228 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1228 may include one or more virtual storage resources (e.g., cloud storage, a virtual private network, and/or other virtual storage resources). Electronic storage 1228 may store software algorithms, information determined by processor 1230, information received from online community platform 1202, information received from client computing platforms 1206, and/or other information that enables online community platform 1202 to function as described herein.

Processor(s) 1230 is configured to provide information processing capabilities in online community platform 1202. As such, processor 1230 may include one or more of a digital processor, an analog processor, a digital circuit designed to process information, an analog circuit designed to process information, a state machine, and/or other mechanisms for electronically processing information. Although processor 1230 is shown in FIG. 12 as a single entity, this is for illustrative purposes only. In some implementations, processor 1230 may include a plurality of processing units. These processing units may be physically located within the same device, or processor 1230 may represent processing functionality of a plurality of devices operating in coordination. The processor 1230 may be configured to execute modules 1210, 1212, 1216, 1218, 1220, 1222, and 1224. Processor 1230 may be configured to execute modules 1210, 1212, 1216, 1218, 1220, 1222, and 1224 by software; hardware; firmware; some combination of software, hardware, and/or firmware; and/or other mechanisms for configuring processing capabilities on processor 1230. As used herein, the term “module” may refer to any component or set of components that perform the functionality attributed to the module. This may include one or more physical processors during execution of processor readable instructions, the processor readable instructions, circuitry, hardware, storage media, or any other components.

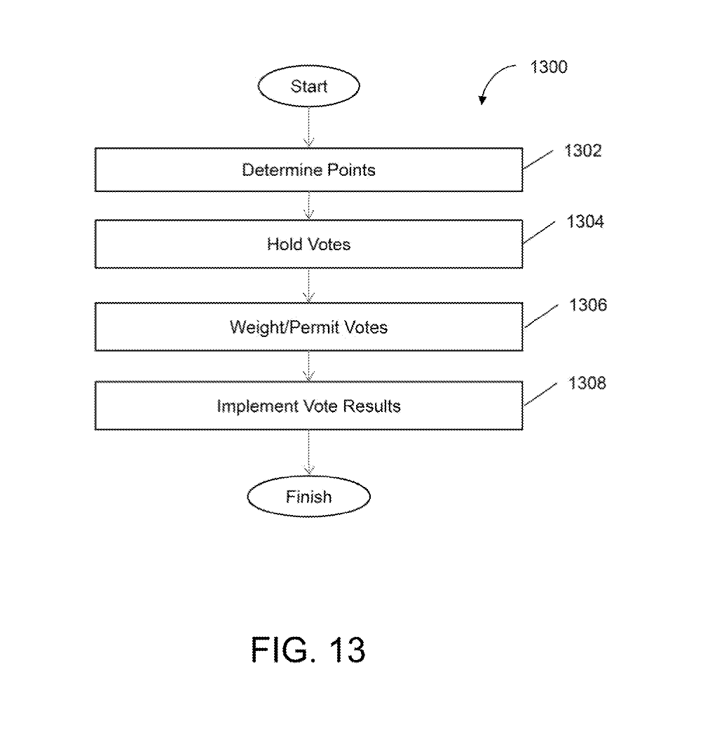

FIG. 13 illustrates a method 1300 of self-governing online communities. The operations of method 1300 presented below are intended to be illustrative. In some embodiments, method 1300 may be accomplished with one or more additional operations not described, and/or without one or more of the operations discussed. Additionally, the order in which the operations of method 1300 are illustrated in FIG. 13 and described below is not intended to be limiting.

In some embodiments, method 1300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300.

At an operation 1302, a number of points associated with each member of an online community may be determined. The number of points for each member may be based at least in part on the member's involvement in the online community, including quantity and quality of involvement. Operation 1302 may be performed by a points module that is the same as or similar to points module 205 and/or 1210, in accordance with one or more implementations.

At an operation 1304, it may be determined when to hold votes and votes may be held accordingly to implement changes in governance of the online community. The number of points for each member may be based at least in part on the member's involvement in the online community, including quantity and quality of involvement. Operation 1304 may be performed by a rules module, election module, voting module, and/or trigger module that are the same as or similar to rules module 210, election module 215, voting module 1212, trigger 212/222, and/or trigger module 1216, in accordance with one or more implementations.

At an operation 1306, votes by members of the online community may be permitted and/or weighted at least in part based on the number of points associated with the members. Operation 1306 may be performed by a weighting module that is the same as or similar to weighting module 1224, in accordance with one or more implementations.

At an operation 1308 results of the votes may be implemented. Operation 1308 may be performed by a results module that is the same as or similar to weighting module 235, in accordance with one or more implementations.

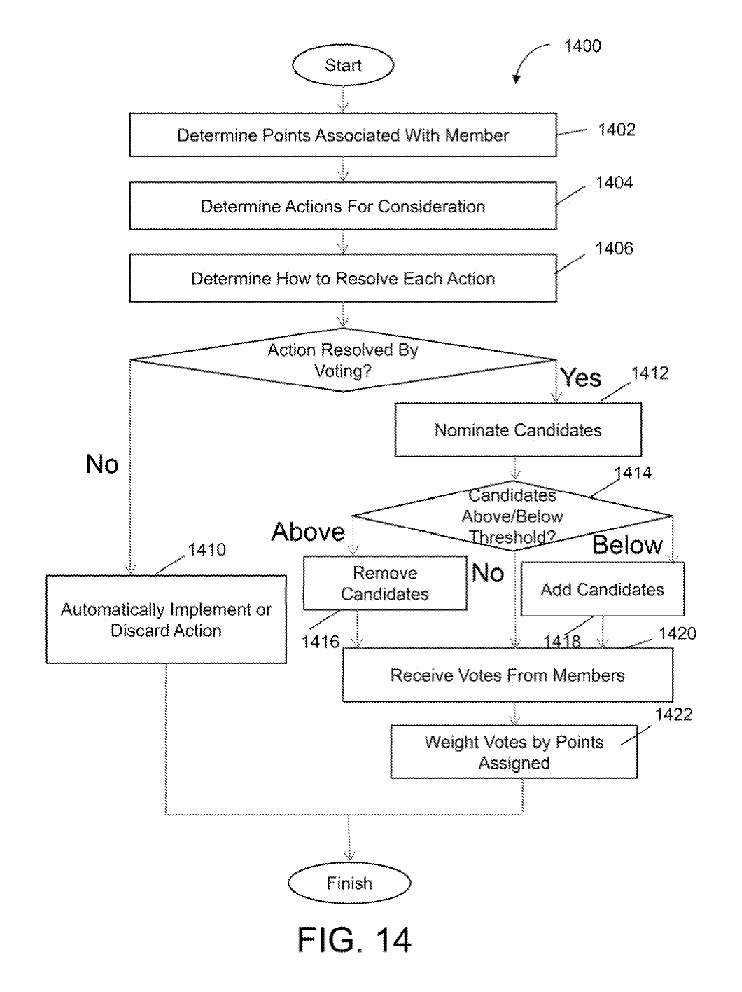

FIG. 14 illustrates a method 1400 of self-governing online communities. The operations of method 1400 presented below are intended to be illustrative. In some embodiments, method 1400 may be accomplished with one or more additional operations not described, and/or without one or more of the operations discussed. Additionally, the order in which the operations of method 1400 are illustrated in FIG. 14 and described below is not intended to be limiting.

In some embodiments, method 1400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1400 in response to instructions stored electronically on an electronic storage medium. The one or more processing devices may include one or more devices configured through hardware, firmware, and/or software to be specifically designed for execution of one or more of the operations of method 1400.

At an operation 1402, a number of points associated with each member of an online community may be determined. The number of points for each member may be based at least in part on the member's involvement in the online community, including quantity and quality of involvement. Operation 1402 may be performed by a points module that is the same as or similar to points module 205 and/or 1210, in accordance with one or more implementations.

At an operation 1404, actions associated with governance of the online community may be determined for consideration. Determination of actions for consideration may be based on a trigger, such as a time or population trigger or member demand. Operation 1404 may be performed by a rules module, election module, voting module, and/or trigger module that are the same as or similar to rules module 210, election module 215, voting module 1212, trigger 212/222, and/or trigger module 1216, in accordance with one or more implementations.

At an operation 1406, whether to resolve each action by voting is decided. Operation 1406 may be performed by a rules module, election module and/or algorithm module that is the same as or similar to rules module 210, election module 215, and/or algorithm module 230, in accordance with one or more implementations.

At an operation 1412, candidates are nominated for actions determined to be resolved by voting. Nominations may be algorithmic or member-supplied (and in some embodiments may be supplied by a subset of members such as administrators only). In other embodiments, candidates may be nominated for actions determined not to be resolved by voting. Operation 1412 may be performed by a nomination module that is the same as or similar to nomination module 1220, in accordance with one or more implementations.

At an operation 1414, it may be determined whether nominated candidates are above or below a threshold value. If the number of nominated candidates is above the threshold, candidates may be removed at operation 1416, while if the number of nominated candidates is below the threshold, candidates may be added at operation 1420. Operations 1414, 1416 and 1418 may be performed by a nomination module that is the same as or similar to nomination module 1220, in accordance with one or more implementations.

At an operation 1420, votes may be received from members. Operation 1420 may be performed by a voting module, rules module and/or election module that is the same as or similar to voting module 1212, rules module 210 and/or election module 220, in accordance with one or more implementations.

At an operation 1420, votes may be weighted by the number of points assigned to each member. Operation 1420 may be performed by a weighting module, rules module and/or election module that is the same as or similar to weighting module 1224, rules module 210 and/or election module 220, in accordance with one or more implementations.

At an operation 1408 actions determined to be resolved without voting may be automatically implemented or discarded. Operation 1408 may be performed by an algorithm module that is the same as or similar to algorithm module 230, in accordance with one or more implementations.

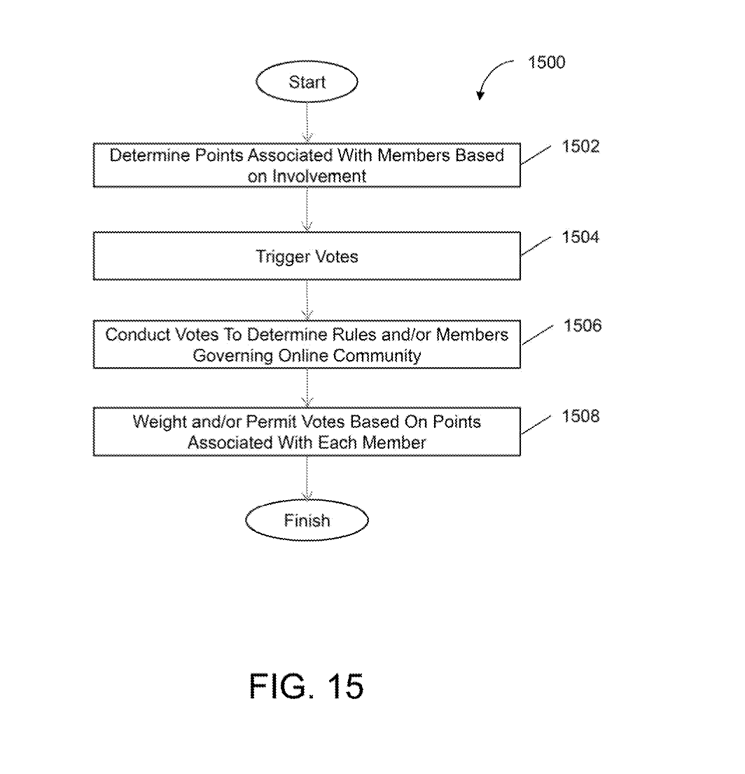

FIG. 15 illustrates a method 1500 of self-governing online communities. The operations of method 1500 presented below are intended to be illustrative. In some embodiments, method 1500 may be accomplished with one or more additional operations not described, and/or without one or more of the operations discussed. Additionally, the order in which the operations of method 1500 are illustrated in FIG. 15 and described below is not intended to be limiting.

In some embodiments, method 1500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1500 in response to instructions stored electronically on an electronic storage medium. The one or more processing devices may include one or more devices configured through hardware, firmware, and/or software to be specifically designed for execution of one or more of the operations of method 1500.

At an operation 1502, a number of points associated with each member of an online community may be determined based at least in part on the member's involvement in the online community, including quantity and quality of involvement. Operation 1502 may be performed by a points module that is the same as or similar to points module 205 and/or 1210, in accordance with one or more implementations.

At an operation 1504, votes are triggered. Votes may be triggered for example by member demand, by the passage of a certain amount of time, or by growth of the community to a certain size. Operation 1504 may be performed by a trigger module that is the same as or similar to trigger module 1216, in accordance with one or more implementations.

At an operation 1506, votes may be conducted to determine rules and/or members (such as administrators) governing the online community. Operation 1506 may be performed by a voting module that is the same as or similar to voting module 1212, in accordance with one or more implementations.

At an operation 1508, votes by members of the online community may be weighted and/or permitted at least in part based on the number of points associated with the members. Operation 1508 may be performed by a weighting module that is the same as or similar to weighting module 1224, in accordance with one or more implementations.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Python, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for self-governing an online community, the system comprising:
one or more computing devices configured to execute modules, the modules comprising:
a points module configured to determine a number of points associated with each of a plurality of members of an online community, wherein the number of points associated with each member is based on involvement of the associated member in the online community;
at least one of a rules module and an election module having a trigger and configured to hold votes to implement changes in governance of the online community, wherein the trigger determines when a vote should be held; and
a results module configured to implement results of votes;
wherein at least one of the ability to vote and the vote weights of each of the plurality of members of the online community in a vote held by the rules module or election module is based on the number of points associated with each member.

2. The system of claim 1, wherein the at least one of a rules module and an election module comprises a rules module configured to determine a set of rules governing conduct for the members of the online community and the rules module trigger determines when a vote should be held on whether to implement one or more rules.

3. The system of claim 1, wherein the at least one of a rules module and an election module comprises an election module configured to determine a set of rules governing elections of administrators for the online community and the election module trigger determines when a vote should be held to elect one or more administrators.

4. The system of claim 1, wherein the modules further comprise an algorithm module configured to perform at least one of the following operations without conducting a vote: a) adopt one or more rules for the online community; b) select one or more rules to be voted on for implementation in the online community; c) elect one or more administrators for the online community; and d) select one or more candidates for an election for one or more administrators for the online community.

5. The system of claim 4, wherein the algorithm module is configured to select, without conducting a vote, one or more candidates from the members of the online community for an election for one or more administrators for the online community, based on at least one of the number of points the members have, how long the members have been a member of the online community, the number of other members of the online community who endorse the members, population and age of the online community, number of posts made in the online community, number of comments made in the online community, number of members that leave the online community, and the number of infractions or number of rules broken within the online community 140.

6. The system of claim 1, further comprising a punishment module configured to implement actions to punish a member of the online community that breaks one of the online community's rules.

7. The system of claim 1, further comprising a nomination module configured to determine candidates to be voted on in the election.

8. The system of claim 1, further comprising an endorsement module configured to receive and tabulate endorsements for election candidates from other members of the online community.

9. A method of self-governing an online community, comprising:
determining a number of points of at least one member of an online community, wherein the number of points for the at least one user is associated with the member's activity on the online community;
determining that actions associated with governance of the online community should be considered;
determining whether each action should be resolved by voting;
for actions determined to be resolved by voting:
receiving votes on whether to implement the actions from members of the online community; and
weighting the votes received by the number of points assigned to each member; and
automatically implementing or discarding actions determined to be resolved without voting.

10. The method of claim 9, wherein one or more of the actions are associated with implementing one or more rules governing conduct for members of the online community.

11. The method of claim 9, wherein one or more of the actions are associated with election of one or more administrators of the online community.

12. The method of claim 11, further comprising nominating candidates for the election.

13. The method of claim 12, wherein the election is determined to be resolved without voting and winning candidates are chosen via an algorithmic process.

14. The method of claim 12, wherein the candidates are nominated via member endorsements.

15. The method of claim 12, further comprising:
determining that a number of nominated candidates is above a threshold; and
removing candidates for the election until the number of candidates is below the threshold.

16. The method of claim 15, wherein the removing candidates from the election is based on quantifiable attributes of the candidates.

17. The method of claim 12, further comprising:
determining that a number of nominated candidates is below a threshold; and
adding candidates for the election until the number of candidates is above the threshold.

18. The method of claim 12, wherein the candidates are nominated based on a combination of member endorsements and quantifiable attributes of the candidates.

19. A system for self-governing an online community, the system comprising:
one or more processors configured to execute computer program modules, the computer program modules comprising:
a points module configured to determine a number of points associated with each of a plurality of members of an online community, wherein the number of points associated with each member is based on involvement of the associated member in the online community;
a voting module configured to conduct votes to determine administrators of the online community or rules governing the online community;
a trigger module configured to trigger a vote conducted by the voting module; and
a weighting module configured to weight or permit votes of each of the plurality of members of the online community based at least in part on the number of points associated with each member.
